(19) United States
(12) Patent Application Publication
(10) Pub. No.: US 2026/0097413 A1
(43) Pub. Date: Apr. 9, 2026

(54) AUTONOMOUS SYSTEM AND METHOD FOR CLEANING NOZZLES USING WATER FOR SPRAYERS

(71) Applicant: TECSOIL AUTOMAÇÃO E SISTEMAS S.A., Araçatuba (BR)

(72) Inventors: Danilo Teodoro Alves, Araçatuba (BR); Felipe Yuri Hirata Teixeira, Araçatuba (BR); Guilherme Nunes Pellegrino, Araçatuba (BR)

(73) Assignee: TECSOIL AUTOMAÇÃO E SISTEMAS S.A., Araçatuba, SP (BR)

(21) Appl. No.: 19/349,222

(22) Filed: Oct. 3, 2025

(30) Foreign Application Priority Data
Oct. 3, 2024 (BR) 102024020526-0

(51) Int. Cl. B05B 15/555; B01D 29/66

(52) U.S. Cl. CPC B05B 15/555; B01D 29/66

(57) ABSTRACT

The present invention relates to an autonomous method and system for cleaning spray nozzles using water. In order to clean the spray system a pump is used to pressure the water that is directed to the nozzle, the water passing through a separate, dedicated cleaning line, focusing on the nozzle cleaning or nozzle and sieve cleaning. The water is contained in a reservoir tank and, when used, is subsequently discharged into the environment, where the wastewater will contain product residue.

### FIELD OF THE INVENTION

The present invention falls within the field of cleaning the nozzle and sieve of spraying machines.

### BACKGROUND OF THE PRIOR ART

The sprayer cleaning and decontamination process is an essential part of equipment setup and is a simple yet important practice, as it helps prevent phytotoxicity problems and increases the durability of the sprayer.

By preparing sprayers for application, many people skilled in the art and operators believe it simply involves marking out an area, checking the spray volume the equipment is applying to, and adjusting the work speed and/or operating pressure. However, this is a misconception! Effective spraying requires much more than that.

To ensure successful application and achieve the desired goals, sprayer preparation must begin long before checking the spray volume. It is crucial that everyone involved in the operation understands the difference between two distinct concepts: adjusting and calibrating. Simply put, adjusting is the process of preparing the sprayer for calibration and subsequent use, which includes ensuring the equipment is properly maintained. Calibration, in turn, refers to checking and adjusting the spray volume as desired, in addition to defining the amount of product to be added to the tank.

Therefore, if a sprayer is not properly regulated, there is a significant risk of it not being calibrated correctly, which can result in serious crop problems, shorten the equipment's lifespan, and even affect operator safety. Studies conducted on Brazilian cultivations disclose a significant lack of sprayer maintenance. Data from the IPP (Periodic Sprayer Inspection of Unesp in Botucatu, São Paulo) indicate a loss of approximately 23% due to inadequate maintenance.

Effective adjustments involve not only a detailed understanding of how the sprayer works, but also an understanding of how the products used interact with the equipment. Many products can accumulate in hard-to-reach areas and remain there for prolonged periods, contaminating cultivations and altering the chemical and physical composition of other products. Furthermore, they can cause blockages in pipes, valves, filters, and nozzles, and in more severe cases, lead to corrosion of important components of the hydraulic system. Therefore, during adjustments, it is essential to meticulously clean the sprayer using specific cleaning agents and in an appropriate location. Cleaning should follow basic procedures which may vary depending on the specific situation. Below are some recommended actions for this task.

Currently, the market offers some alternatives for cleaning sprayer nozzles, such as the use of compressed air, where the air is expelled through the nozzle orifice, and the use of water, albeit manually.

US20240109094A1 relates to an agricultural sprayer cleaning assembly consisting of: a cleaning agent reservoir configured to contain a cleaning agent; a rinse reservoir configured to receive the rinse formed by the cleaning agent and an agricultural product; a system interface in selective communication with the rinse reservoir or the cleaning agent reservoir, the system interface being configured to be coupled to the agricultural sprayer piping; and a cleaning control system configured to clean the agricultural sprayer piping.

US20210154604A1 relates to a filtration system for a sprayer and associated methods and devices (collectively, a sprayer filtration system). The filtration system includes a return line from a filtration apparatus located between a product tank and one or more nozzles, and directing the returned fluid to an agitation mechanism in the product tank of a sprayer vehicle.

US20220264862A1 discloses a system for purging the nozzles of an agricultural sprayer. The system includes a pressurized air source, a main fluid conduit fluidly coupled to the pressurized air source, and a main valve configured to selectively allow air from the pressurized air source to flow through the main fluid conduit.

The prior art cited above lacks unique characteristics that will be discussed in detail below. None of the conventional nozzle cleaning documents or systems utilize the technology presented herein.

Given the challenges present in the aforementioned prior art, and for nozzle cleaning solutions, the need arises to develop a technology capable of performing effectively and complying with environmental and safety guidelines. The aforementioned prior art lacks unique characteristics that will be detailed below.

### OBJECTIVES OF THE INVENTION

The objective is to provide a system and method capable of cleaning the nozzle and sieve of a spraying machine, conducting preventive maintenance to prevent obstructions in the system, using a pressurized water system to perform such cleaning.

### SUMMARY OF THE INVENTION

The present invention relates to an autonomous method and system for cleaning spray nozzles using water for sprayers. In order to clean the spray system, a pump is used to pressurize the water that is directed to the nozzle, the water passing through a separate, dedicated cleaning line, focusing on the nozzle cleaning or nozzle and sieve cleaning. The water will be contained in a reservoir tank and, when used, is subsequently discharged into the environment, where the wastewater will contain product residue.

### BRIEF DESCRIPTION OF THE DRAWINGS

The present invention will be described in more detail below with reference to the attached figures which, in a schematic manner and not limiting the inventive scope, represent examples of its embodiment. The drawings show:

FIG. 1 illustrates the autonomous nozzle cleaning system;

FIG. 2 illustrates the self-cleaning nozzle.

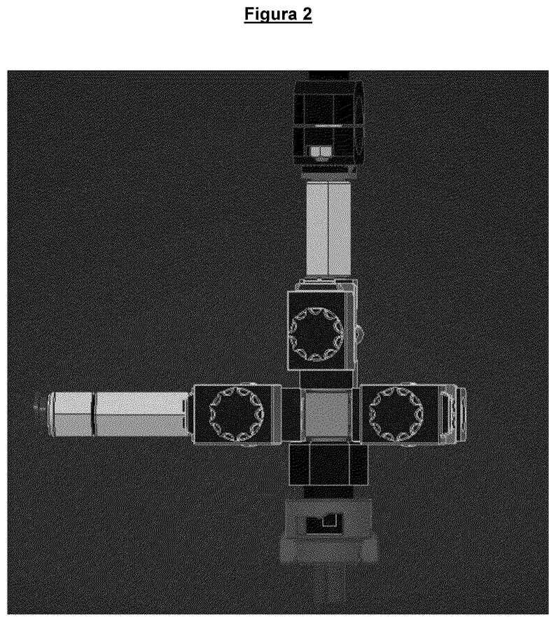

### DETAILED DESCRIPTION OF THE INVENTION

Below is a detailed description of a preferred embodiment of the present invention, which is exemplary and in no way limiting. However, possible additional embodiments of the present invention, still encompassed by the essential and optional features below, will become clear to one skilled in the art upon reading this description.

The autonomous water spraying system was developed to solve operational problems in the field, eliminating the need to interrupt operations to clean nozzles. This avoids operational downtime, which generates additional costs.

The solution proposed by the present invention has a cleaning objective focused on preventive maintenance, whereby the nozzle and sieve of spraying machines are cleaned to prevent clogging of the spraying system. Compared to other solutions that use different methods, such as filtration process or even compressed air, the solution of the present invention uses pressurized water to clean the nozzle, and after cleaning, the resulting residue is discarded.

Comparing the cleaning process, which uses a cleaning agent, such as water or a specific detergent, to clean the application line, the same line is used to clean after the input (herbicide) passes through, and after the cleaning process, it is collected in a dedicated tank. Any product residue remaining in the line is taken to the tank. Depending on the product, a neutralizer may be required, which is also sent to the tank. Regarding the solution of the present invention, where we have a separate line, we use pressurized water for localized cleaning, that is, cleaning the nozzle and sieve. Thus, the present invention can perform localized cleaning of the nozzle and also general cleaning, cleaning the nozzle and sieve.

Comparing the prior art processes, we see that the solution used in this invention differs from others, both in terms of equipment and method, and in terms of cleaning objective. The present invention utilizes a separate line, pressurized water, a different cleaning time, and a different method for cleaning the nozzle and sieve, through which pressurized water is used for preventive cleaning.

The spray bar nozzle becomes clogged after a period of application. Due to the reaction of the chemical used, product residues can accumulate and clog the nozzle and sieve, making the product application process difficult.

To clean the spray system, a pump is used to pressurize the water that is directed to the nozzle, the water passes through a separate, dedicated cleaning line, focusing on the nozzle cleaning or nozzle and sieve cleaning. The water is contained in a reservoir tank and, when used, is subsequently discharged into the environment, where the wastewater will contain product residue.

The system uses three solenoid valves: one for feedstock input (herbicide), another for water input for cleaning, and the third for water output from the system, which can be collected in a reservoir or discharged into the environment.

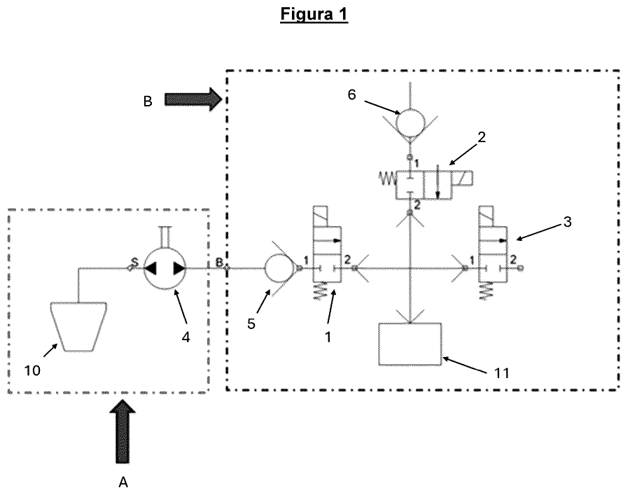

FIG. 1 illustrates solenoid valves wherein:
a) Water system inlet valve (1), where water will enter to clean both the nozzle and the sieve
b) Valve through which the input will enter (2), this valve is opened when there is an application
c) Water outlet valve (3), where when there is a general cleaning, the water comes out into the environment.

The system comprises the followings components:
1 Water pump (4);
3 solenoid valves (1, 2, 3);
2 one-way valves (5, 6);
1 Crosshead (7);
2 Pneumatic straight connection (8, 9);
1 Water tank (10);
1 Spray nozzle (11).

The system can perform preventive cleaning of the nozzles and sieve using pressurized water. During the herbicide application process, residue can accumulate in the nozzles, clogging them and the sieve.

Thus, to eliminate waste, the system is capable of performing in two ways: the first cleans in general and the second in a localized mode.

When using localized mode, the herbicide valve (2) closes and the water valve (1) opens, causing water to flow out of the spray nozzle (11). Since there is only one outlet, the system focuses on cleaning the spray nozzle (11).

When using the general mode, the herbicide valve (2) closes, the water inlet (1) opens, and the water outlet (3) also opens. Thus, the water flow ends up passing through the sieve and the nozzle (11), which is finally discharged into the environment.

1. AN AUTONOMOUS SYSTEM FOR CLEANING NOZZLES USING WATER FOR SPRAYERS comprising 1 Water pump (4); 3 Solenoid valves (1, 2, 3); 2 One-way valves (5, 6); 1 Crosshead (7); 2 Straight pneumatic connection (8, 9); 1 Water tank (10); 1 Spray nozzle (11).

2. AN AUTONOMOUS METHOD FOR CLEANING NOZZLES USING WATER FOR SPRAYERS, using the system as defined in claim 1, comprising two cleaning steps:
Localized step: close the herbicide valve (2) and open the water valve (1), allow water to flow out of the sprayer nozzle (11), and clean the sprayer nozzle (11);
General step: close the herbicide valve (2), open the water inlet valve (1), and open the water outlet valve (3); pass the water flow through the sieve and through the nozzle (11); discharge the flow to the environment.
